(19) United States
(12) Patent Application Publication
(10) Pub. No.: US 2018/0291894 A1
(43) Pub. Date: Oct. 11, 2018

(54) ENGINE OIL PUMP

(71) Applicant: SABIC Global Technologies B.V., Bergen op Zoom (NL)

(72) Inventors: Subhransu Sekhar MOHAPATRA, Bangalore (IN); Lenar ABBASOV, West Bloomfield, MI (US); Fred CHANG, Wixom, MI (US); R N Ashwin KUMAR, Bangalore (IN); Steven MCCLINTOCK, South Lyon, MI (US); Arunachala PARAMESHWARA, Bangalore (IN); Raghavendra JANIWARAD, Bangalore (IN)

(21) Appl. No.: 15/767,415

(22) PCT Filed: Oct. 12, 2016
(86) PCT No.: PCT/US2016/056579

§ 371 Date: Apr. 11, 2018

(30) Foreign Application Priority Data
Oct. 12, 2015 (IN) 3261/DEL/2015

(51) Int. Cl. F04C 2/344; F01C 21/10; F01M 1/02; F04C 14/22

(52) U.S. Cl. CPC F04C 2/3441; F01C 21/10; F01M 1/02; F05C 2225/00; F01M 2001/0238; F04C 2240/30; F04C 2240/56; F04C 14/226

(57) ABSTRACT

A variable displacement pump, and methods of manufacturing such systems are provided. The variable displacement pump can include a housing defining an inlet and an outlet, a rotor positioned between the inlet and the outlet, the rotor being configured to pump a liquid between the inlet and the outlet, and the rotor having a multiple of vane slots, a multiple of vanes, each disposed in a respective one of the multiple of vane slots, and a pendulum positioned between the rotor and the housing, the pendulum comprising a pendulum body and a stiffener, wherein the stiffener is located at least partially within the pendulum body, and wherein the rotor, the multiple of vanes, and the pendulum body are made of a polymer.

### CROSS REFERENCE TO RELATED APPLICATIONS

This application claims the benefit of and priority to Indian Patent Application No. 3261/DEL/2015, filed Oct. 12, 2015, which is hereby incorporated herein by reference in its entirety.

### TECHNICAL FIELD

This document pertains generally, but not by way of limitation, to pumps, and more particularly to engine oil pumps.

### BACKGROUND

Automotive original equipment manufacturers (OEMs) are under pressure to reach increasingly stringent fuel economy and emissions performance goals. An efficient automotive lubrication system, such a rotary pump, can significantly help in meeting these goals. Rotary pumps can be fixed displacement or variable displacement pumps.

Fixed displacement oil pumps typically have oversized pumps to handle harsh engine operating conditions. Fixed displacement oil pumps can also contain pressure-relief valves as one way to avoid excessively high oil pressures, but these designs can be inefficient. Accordingly, fixed oil pumps often consume more power and deliver significantly higher oil pressure than needed.

Variable displacement oil pumps help to minimize energy losses, as they can be actively controlled to match the oil flow and pressure needs of the engine, reducing or eliminating excess oil flow and reducing the load on the engine crankshaft, resulting in fuel savings. In variable displacement pumps, the displacement volume can be changed so as to control the flow rate. Such pumps can have hydraulic and electrical controls and actuators to vary the eccentricity of the rotor.

Current variable displacement oil pumps are often made of metals such as cast aluminum and steel. Also, these designs can result in intricate mechanisms to improve efficiency, as compared to fixed displacement pumps, which can result in a higher part count and a higher cost. Also, the high friction between moving-moving or moving-static parts can result in parasitic losses that reduce the overall powertrain efficiency. Additionally, since metals are typically not good dampeners, this results in higher noise, vibration, and harshness (NVH), which can require further design features to compensate for the increased NVH.

An example of a rotary pump is disclosed in U.S. Pat. No. 6,821,099 to Wilk et al. The system is directed to a dual chamber or double sided rotary pump that includes a stator housing and a rotor, where the stator housing, the rotor, and the vanes are manufactured from plastic.

Accordingly, there is a need for improved engine oil pumps. Various examples of the disclosure may solve one or more of these problems.

### OVERVIEW

The present inventors have recognized, among other things, that a problem to be solved can include a need for improved engine oil pumps. The present subject matter can help provide a solution to this problem, such as by providing an engine oil pump where a shaft and a pendulum stiffener can be made of metal, while many or all of the remainder of the pump components can be made of a non-metal (e.g., a plastic or a composite).

In one example, a variable displacement pump, including a housing defining an upper surface, a lower surface opposite the upper surface, and an outer surface extending between the upper surface and the lower surface, the housing including an inlet and an outlet, the housing further defining an opening sized to receive a shaft, a cover coupled to the upper surface of the housing, the cover defining an opening sized to receive the shaft, a rotor positioned in the housing between the inlet and the outlet, the rotor defining an opening sized to receive the shaft, and the rotor being configured to pump a liquid between the inlet and the outlet, wherein the rotor defines a multiple of vane slots, a multiple of vanes, each disposed in a respective one of the multiple of vane slots, and a pendulum positioned between the rotor and the housing, the pendulum comprising a pendulum body and a stiffener, wherein the stiffener is located at least partially within the pendulum body, and wherein the rotor, the multiple of vanes, and the pendulum body are made of a polymer.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various examples discussed in the present document.

FIG. 1A illustrates an exploded view of a variable displacement vane pump according to an example of the disclosure.

FIG. 1B illustrates an assembled view of a variable displacement vane pump according to an example of the disclosure.

FIG. 2 illustrates a cross-sectional view of the variable displacement vane pump in FIG. 1B after assembly taken along the line 2-2 according to an example of the disclosure.

FIG. 3A illustrates a top view of a cover for a housing for the variable displacement vane pump according to an example of the disclosure.

FIG. 3B illustrates a bottom view of the cover according to an example of the disclosure.

FIG. 3C illustrates a cross-sectional view of the cover taken along the line 3C-3C of FIG. 3A according to an example of the disclosure.

FIG. 3D illustrates a perspective view of a bushing for the variable displacement vane pump according to an example of the disclosure.

FIG. 4A illustrates a side view of the housing for the variable displacement vane pump according to an example of the disclosure.

FIG. 4B illustrates another side view of the housing for the variable displacement vane pump according to an example of the disclosure.

FIG. 5A illustrates a perspective view of a pendulum for the variable displacement vane pump according to an example of the disclosure.

FIG. 5B illustrates a perspective view of an insert for the pendulum according to an example of the disclosure.

FIG. 5C illustrates a cross-sectional view taken along the line 5C-5C of FIG. 5A according to an example of the disclosure.

FIG. 5D illustrates a side view of the pendulum according to another example of the disclosure.

FIG. 5E illustrates a side view of the pendulum according to another example of the disclosure.

FIG. 6A illustrates a perspective view of a rotor for the variable displacement vane pump according to an example of the disclosure.

FIG. 6B illustrates a side view of the rotor according to an example of the disclosure.

FIG. 6C illustrates a cross-sectional view of the rotor taken along the line 6C-6C of FIG. 6A according to an example of the disclosure.

FIG. 7A illustrates a top view of a vane for the variable displacement vane pump according to an example of the disclosure.

FIG. 7B illustrates a side view of the vane in a transverse direction T of FIG. 7A according to an example of the disclosure.

FIG. 7C illustrates a side view of the vane in an axial direction A of FIG. 7A according to an example of the disclosure.

FIG. 8 illustrates a perspective view of a vane ring for the variable displacement vane pump according to an example of the disclosure.

FIG. 9 illustrates a perspective view of a shaft for the variable displacement vane pump according to an example of the disclosure.

FIG. 10A illustrates a side view of the housing with a pick-up tube and a change gear for the variable displacement vane pump according to an example of the disclosure.

FIG. 10B illustrates another side view of the housing with a pick-up tube and a change gear for the variable displacement vane pump according to an example of the disclosure.

### DETAILED DESCRIPTION

The present disclosure can be understood more readily by reference to the following detailed description of the disclosure and the examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting.

Various combinations of elements of this disclosure are encompassed by this disclosure, e.g., combinations of elements from dependent claims that depend upon the same independent claim.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

Each of the materials disclosed herein are either commercially available and/or the methods for the production thereof are known to those of skill in the art. It is understood that the compositions disclosed herein have certain functions. Disclosed herein are certain structural requirements for performing the disclosed functions and it is understood that there are a variety of structures that can perform the same function that are related to the disclosed structures, and that these structures will typically achieve the same result.

An exemplary example of the disclosure provides an engine oil pump where a shaft and a pendulum stiffener can be made of metal, while many or all of the remainder of the pump components can be made of a non-metal (e.g., a plastic or a composite).

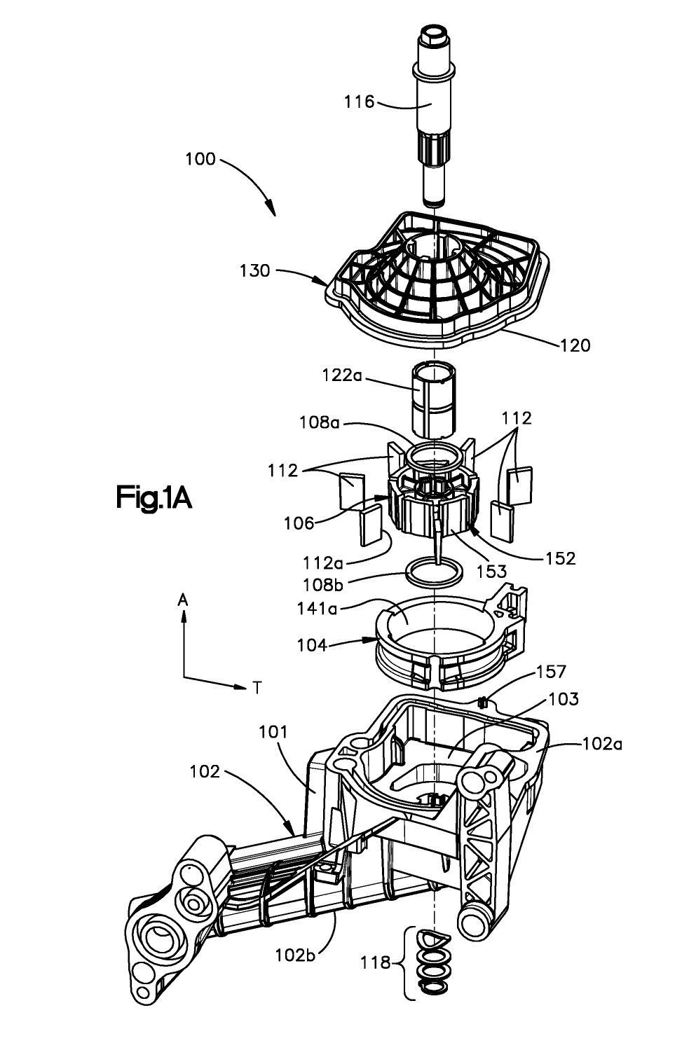

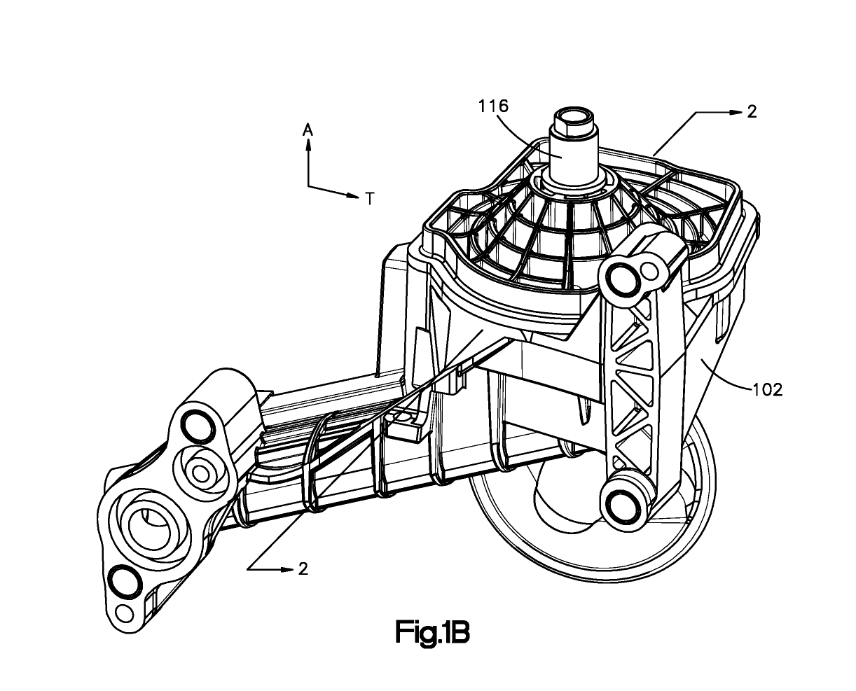

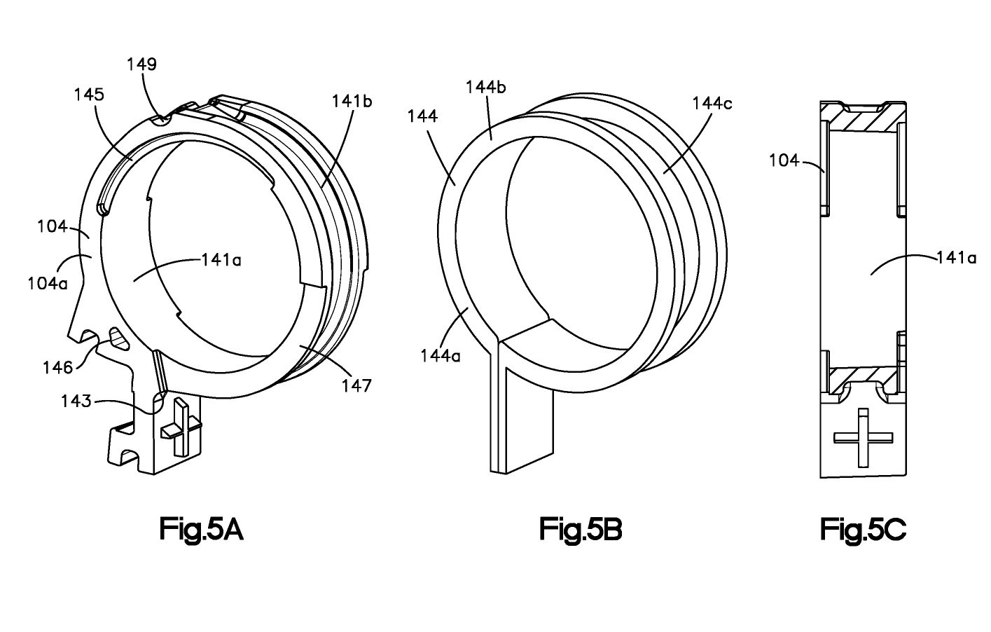

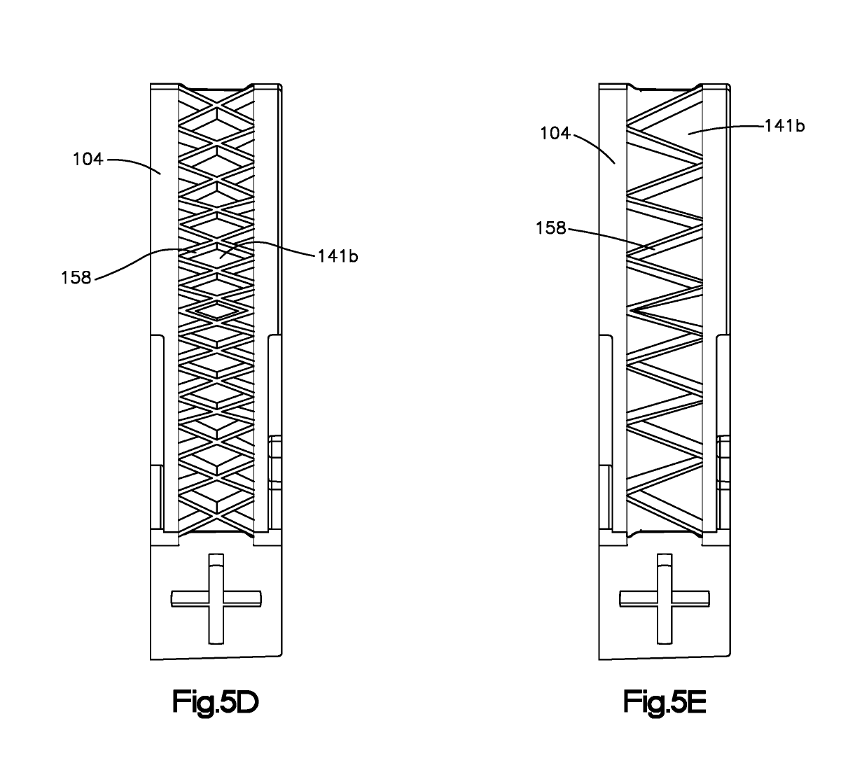

FIGS. 1A-1B illustrate a pump, which can be configured as a variable displacement vane pump 100 in one example. The variable displacement vane pump 100 can include a housing 102 having an upper surface 102a, a lower surface 102b opposite the upper surface 102a, and an outer surface 101 that extends between the upper surface 102a and the lower surface 102b. The housing 102 can further define a cavity 103 that extends into the upper surface 102a along a lateral direction. The housing 102 further includes an inlet 129 and an outlet 139 in fluid communication with the inlet 129. The displacement vane pump 100 can further include a pendulum 104 that is sized to be placed in the cavity 103 of the housing 102. The variable displacement vane pump 100 further includes a rotor 106 that, in turn, can include a multiple of vanes 112. The rotor 106 can be positioned between the inlet 129 and the outlet 139 to pump or displace a liquid between the inlet 129 and the outlet 139. The rotor 106 is sized to be placed in the cavity 103 within the pendulum 104. As described more fully below (e.g., in reference to FIGS. 5A-5E), in an example, the pendulum 104 can be made of plastic. The variable displacement vane pump 100 further includes a shaft 116 extends along a central axis that is oriented along the lateral direction. The terms “radially inner,” “radially outer,” and derivatives there of refer to a direction toward the central axis or away from the central axis, respectively, unless otherwise indicated. The shaft 116 is rotatbly coupled to the rotor such that, during operation, the shaft 116 is rotatable about the long axis so as to cause the rotor 106 to rotate about an axial direction A. The axial direction A can be coincident with the lateral direction.

The variable displacement vane pump 100 can further include an inner vane ring 108a. The inner vane ring 108a and outer vane ring 108b can be sized to be received in the rotor 106 inside the cavity 103. The variable displacement vane pump 100 can further include a multiple of vanes 112 that are configured to be attached to the rotor 106. The inner vane ring 108a and outer vane ring 108b can be disposed radially inward of the vanes 112 of the rotor 106 so as to be configured to abut the radially inner ends 112a of the vanes 112.

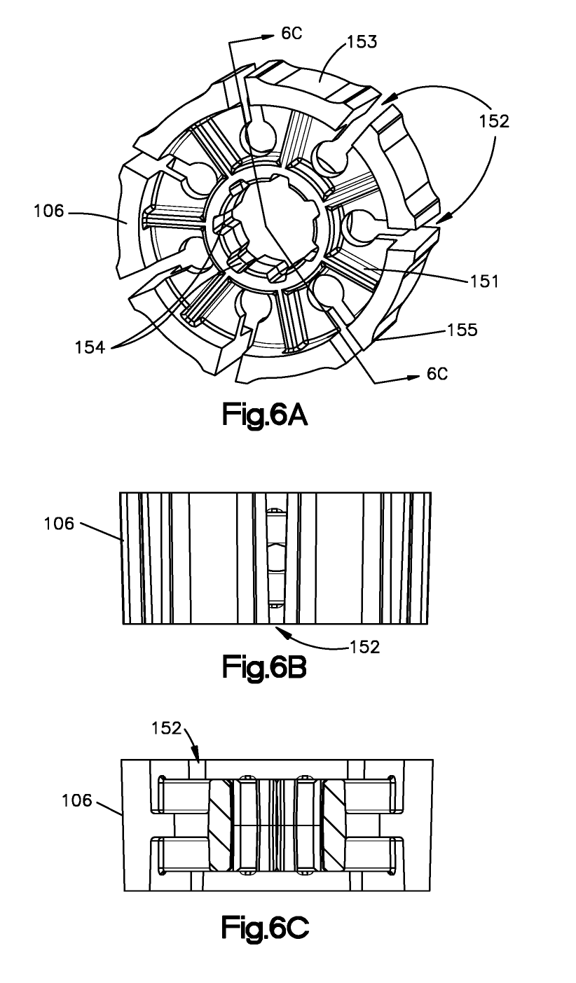

In particular, referring also to FIGS. 6A-6C, the rotor 106 can include a multiple of vane slots 152 that are configured such that the vanes 112 can be inserted into respective ones of the vane slots 152. Accordingly, each of the vanes 112 can be disposed within a respective different one of vane slots 152. In particular, the rotor 106 can define an outer surface 153 that faces away from the central axis, and an inner surface that is opposite the outer surface 153. The vane slots 152 can extend radially inward from the outer surface 153 of the rotor 106 toward the inner surface. In certain examples, each vane 112 rests freely within its corresponding vane slot 152 such that the vanes 112 can slide radially inward or outward in the vane slots 152. As the rotor 106 rotates, the vane rings 108a and 108b can push vanes 112 outward against an inner surface 141 of the pendulum 104.

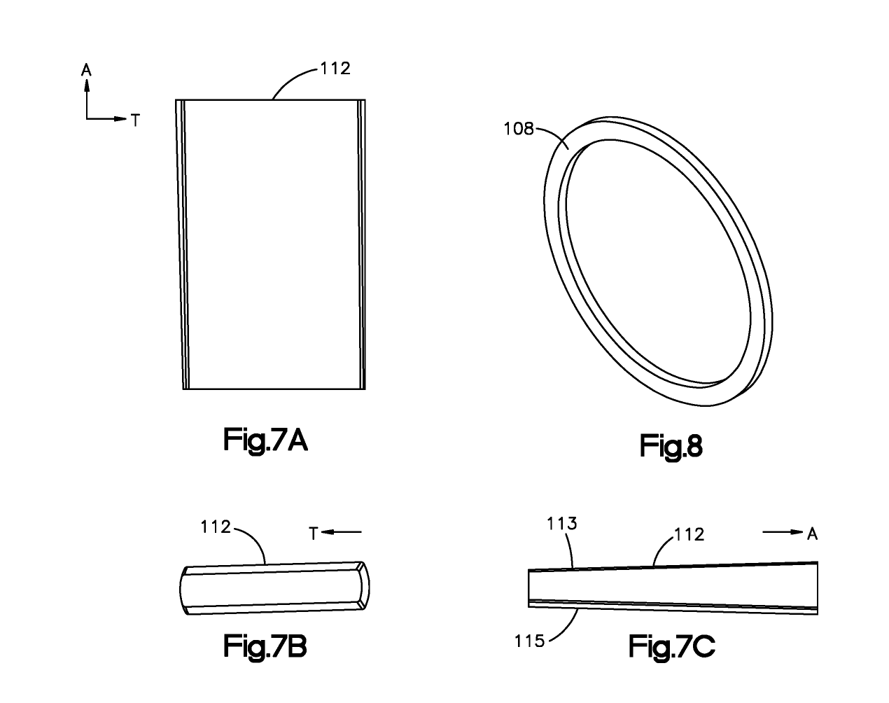

The vane slots 152 can extend radially inward from an outer surface 153 of the rotor 106. In certain examples, each vane 112 rests freely within its corresponding vane slot 152 such that the vanes 112 can slide radially inward or outward in the vane slots 152. As the rotor 106 rotates, the vane rings 108a and 108b can push vanes 112 outward against an inner surface 141 of the pendulum 104. The rotor 106 can include rotor arms 151 between each vane slot 152. In an example, each of the vane slots 152 can be located opposite a spline groove 154. As shown in the rotor 106 of FIG. 6A, for example, there are seven rotor arms 151 and seven vane slots 152, each of the vane slots 152 located opposite a spline groove 154. In other examples, any number of vanes 112 and vane slots 152 can be used. The rotor 106 can be designed with thinner ribs than metal design with ribs added for stiffness to make it moldable. In some examples, the rotor 106 can be driven by a shaft 116 with splines 156 (FIG. 9) that mates with spline grooves 154 in the rotor 106. FIG. 6B illustrates a side view of the rotor 106 according to an example of the disclosure. In FIG. 6B, vane slots 152 are shown where the width of the vane slots 152 at the top of the rotor 106 are wider than the vane slots 152 at the bottom of the rotor 106. The vane slots 152 are angled, as discussed further below in reference to FIGS. 7A-7C, to aid in preventing incorrect insertion of vanes 112 (FIG. 7A). In FIG. 6C a cross-sectional view of the rotor 106 taken along the line 6C-6C of FIG. 6A is shown.

Referring also to FIGS. 7A-7C, alternate views of a vane 112 for the variable displacement vane pump 100 are shown according to an example of the disclosure. FIG. 7A illustrates a top view of a vane 112. In certain examples, vanes 112 can be formed with a draft angle such that they can only be installed by being inserted in the proper orientation to match the draft angle of the vane slots 152. In some examples, the draft angle of the vanes 112 can be formed such that they can be matched with a draft angle of the inner surface 141a of the pendulum 104. In an example, the vanes 112 can be made of the PEI material EC008PXQ to provide stiffness, chemical resistance, and dimensional stability. FIG. 7B illustrates a side view of the vane 112 in the transverse direction T of FIG. 7A. In FIG. 7C a side view of the vane 112 in the axial direction A of FIG. 7A is shown. In the vane 112 shown in FIG. 7C, a top side 113 is angled towards the bottom side 115 of the vane 112.

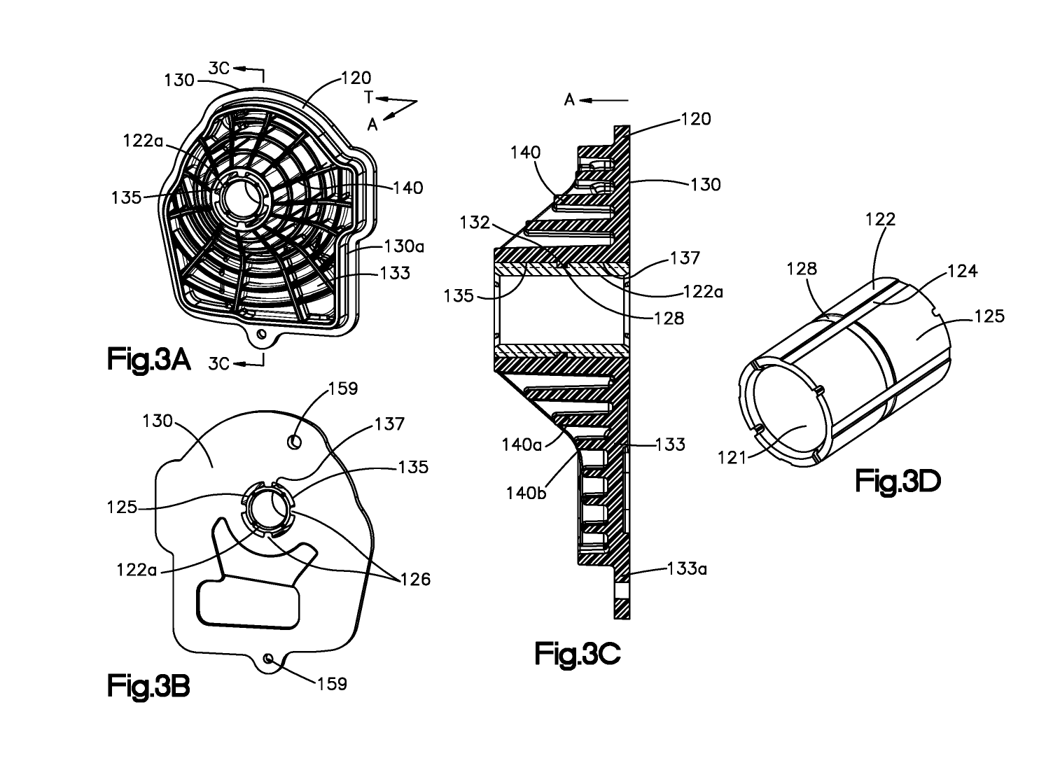

The variable displacement vane pump 100 can further include a cover 130 that can be placed on the housing 102 to cover the rotor 106. The housing 102 can include locator pins 157 that can be inserted into locator pin receiving holes 159 (FIG. 3B) of the cover 130 to properly align the cover 130 on the housing 102. The cover 130 can be welded or otherwise attached to the housing 102. The variable displacement vane pump 100 can further include a first bushing 122a that is sized to receive the shaft 116. The bushing 122a can be retained by the cover 130. The shaft 116 can be inserted into the bushing 122a, such that the bushing 122a rotatably supports the shaft 116.

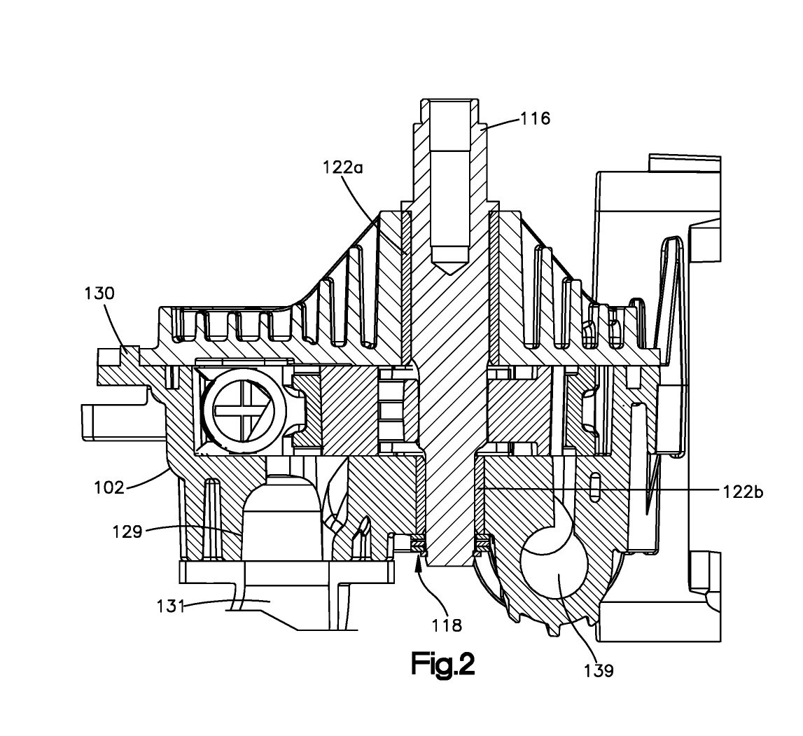

Referring now also to FIG. 2, the variable displacement vane pump 100 can include a multiple of shaft retainers 118 that can retain the shaft 116 in the housing 102. In particular, the shaft retainers 118 can be placed onto a portion of the shaft 116 that can emerge from the bottom of the housing 102. The variable displacement vane pump 100 can further include a second bushing 122b that can be disposed between the shaft 116 and the housing 102 at an opposite side of the housing 102 from the cover 130. Accordingly, the housing 102 can be disposed between the shaft 116 and the cover 130. The housing 102 can define an oil pick-up tube 131 that is in fluid communication with an oil pan (not shown) to deliver a suction to draw oil from the oil pan. The pick-up tube 131 can be made of any suitable material, such as metal or plastic.

The parts shown in FIGS. 1-10 can be made of any suitable material, such as metal (e.g., steel) or plastic. In some examples, the parts shown in FIGS. 1-10 can be made of one or more of polymers such as polyetherimide (PEI), polyetheretherketone (PEEK), Stat-Kon*, Konduit*, Faradex*, Ultem* 2400, Ultem* 3452, Noryl GTX*, or LNP* Thermocomp* Compound EC008PXQ. (*Trademarks of SABIC Global Technologies, B.V.) In certain examples, the material selected for each component part can be capable of operating in temperatures ranging from about 0° C. (degrees Celsius) to 140° C., and with signed von Mises stresses ranging from about −50 MPa (megapascals) to 100 MPa.

Referring now to FIGS. 3A-3D the cover 130 and bushing 122 are shown according to an example of the disclosure. The cover 130 can include a wall 133a that defines an inner surface that faces the housing 102, and an outer surface 133 that is opposite the inner surface. The cover 130 can define an inner hole 135 that extends through the wall 133a from the outer surface 133 to the inner surface. In particular, the cover 130 can include an inside surface 137 that, in turn, defines the inner hole 135. The cover 130 can be substantially dome-shaped so as to increase the stiffness of the cover 130 against internal oil pressure. In certain examples, the cover 130 can include a multiple of ribs 140 that extend out from the outer surface 133 along a direction away from the inner surface. The ribs 140 can also increase strength and stiffness of the cover 130 against internal oil pressure. In one example, the ribs 140 can extend perpendicular to the outer surface 133, though it should be appreciated that the ribs 140 can be alternatively sized and shaped as desired. In some examples, the ribs 140 can have a thickness in the transverse direction T that is less than the thickness of the wall 133a of the cover 130. Each of the ribs 140 can extend to different heights from the outer surface 133, where the height of one 140a of the ribs 140 can be greater than a height of a second one 140b of the ribs 140. In certain examples, the ribs 140 can extend from the outer surface 133 so as to define a multiple of concentrically spaced circles that extend in a transverse direction T outward from the hole 135. In an example the ribs 140 can define a dome shape on the cover 130. The ribs 140 can provide suitable structural performance (e.g., least deflection against internal pressure), dimensional stability (e.g., maintain surface flatness), and manufacturing feasibility (e.g., cooling, etc.). In some examples, the cover 130 can include locator pin receiving holes 159 to properly align the cover 130 with the housing 102 by placing the holes 159 on the locator pins 157 of the housing 102. The cover 130 can include a flange 120 that extends from a perimeter 130a of the cover 130 in the transverse direction T, where the flange 120 is a surface that can be laser welded to the housing 102. In an example, the joining of the cover 130 and the housing 102 can be performed using laser welding. Welding the two parts can eliminate the need for extreme flatness at the flange 120 to prevent leakage. Using welding instead of bolted joint arrangements can reduce the part count and manufacture time. Additionally flange 120 can have different geometries to improve welding strength (e.g., U-joints, V-joints). Various methods of welding can be used including, but not limited to, laser welding, ultrasonic welding, or vibration welding. In other examples, the cover 130 and the housing 102 can be joined through adhesives, crush limiters, elastomeric gaskets, bolted joints, or any suitable method.

One or both of the bushings 122a and 122b can be constructed as illustrated with respect to the bushing 122 shown in FIG. 3D. The bushing 122 defines an annular inner surface 121 and an outer surface 125 that is opposite the inner surface 121. The bushing 122 can include a multiple of grooves 124 that extend into the outer surface toward the inner surface 121. The grooves 124 can be axially oriented and circumferentially spaced from each other. The grooves 124 can terminate at a location between the inner surface 121 and the outer surface 125. In an example, the bushing 122 can define an outer surface 125 and at least one circumferential groove 128 (FIG. 3D) that extends into the outer surface 125. In some examples, the bushing 122 can have a variable thickness between the inner surface 121 and the outer surface 125, such that a thickness between the inner surface 121 and the outer surface 125 of the bushing 122 is greater at one location than another location between the inner surface 121 and the outer surface 125 of the bushing 122. The at least one circumferential groove 128 can extend between adjacent ones of the axial grooves 124. In one example, a single circumferential groove 128 can extend about an entirety of an outer circumference of the bushing 122, and can intersect each of the axial grooves 124.

The inner hole 135 of the cover 130 can be sized to receive the first bushing 122a. Further, the cover 130 can include a multiple of retention ribs 126 that extend from the inside surface 137 into the hole 135 and are sized to be inserted into respective ones of the grooves 124 of the first bushing 122a (FIG. 3D) so as to attach the first bushing 122a to the cover 130. In particular, insertion of the retention ribs 126 into respective ones of the grooves 124 can prevent the first bushing 122a from rotating with respect to the cover 130. In one example, the bushing 122a can be insert molded within the hole 135 of the cover 130. The cover 130 can further include at least one retention rib 132 that extends radially from the inside surface 137 of the cover 130. The retention rib 132 is configured to mate with the circumferential groove 128 in the outer surface 125 of the bushing 122a so as to attach the first bushing 122a to the cover 130. Interference between the retention rib 132 and the first bushing can prevent the first bushing 122a from moving with respect to the cover 130 along the axial direction A. The retention rib 132 mating with the circumferential groove 128 can also act as a barrier to prevent oil leakage from the pump 100 along the outer surface 125 of the first bushing 122a.

In certain examples, the bushing 122 can contain any number of grooves 124 and 128. In the example shown in FIG. 3D, the bushing 122 contains four grooves 124, and one groove 128. In some examples, the thickness of the base 136 of the cover 130 from the inner surface to the outer surface 133 can be about 2-5 mm (millimeters). In an example, the thickness of the outer surface 133 of the cover 130 can be about 3.5 mm. In an example, the bushing 122 can be made of metal, and the cover 130 can be made of plastic. The plastic of the cover 130 can be glass filled or glass and mineral filled polyetherimide (PEI) (e.g., Ultem 2400 or 3452) to allow for high temperature stiffness and strength, chemical resistance, laser weldability, and dimensional accuracy.

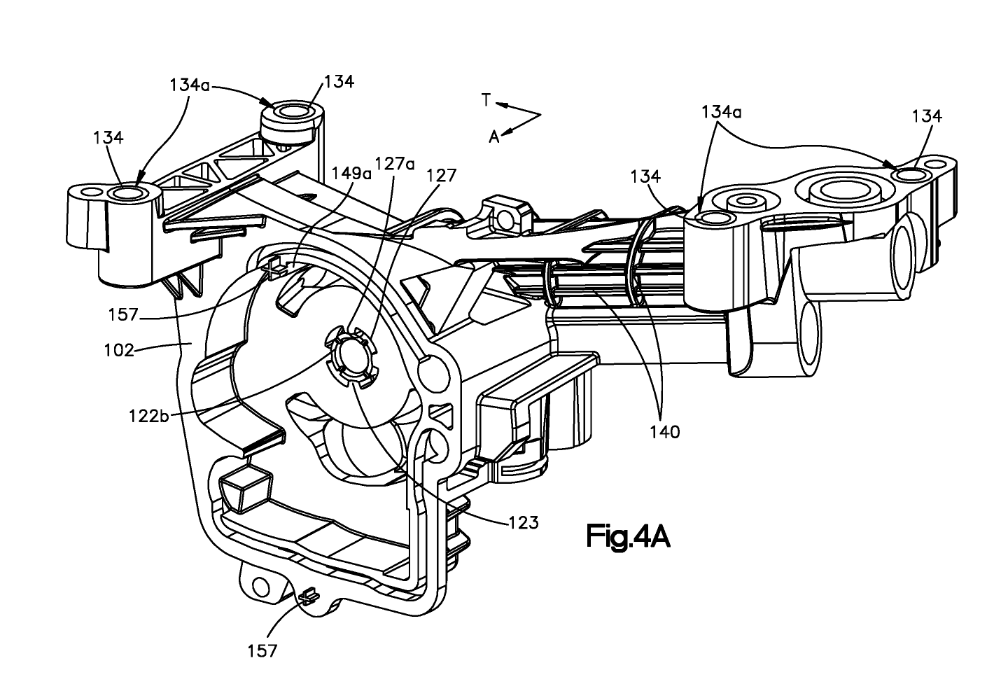

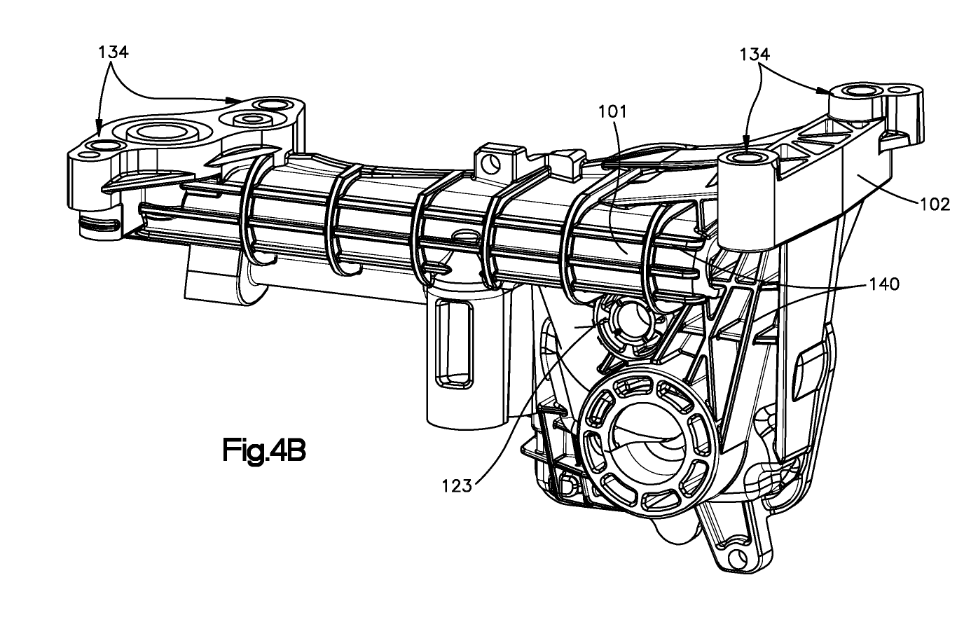

Referring now to FIGS. 4A-4B, the housing 102 can include a multiple of ribs 140 that extend from the outer surface 101 of the housing 102 and increase strength and stiffness of the housing 102. The ribs 140 can extend perpendicular to the outer surface 101 and can be oriented perpendicular to each other. The second bushing 122b can have the same or different dimensions as the first bushing 122a (e.g., length in the axial direction A or diameter in the transverse direction T of first bushing 122a as seen in FIG. 1A). The housing 102 can define a hole 127 that extends in the lateral direction and is sized to receive the second bushing 122b. In particular, the housing 102 can define an inside surface 127a that defines the hole 127. The housing 102 can include a complementary number of retention ribs 123 that extend from the inside surface 127a. The retention ribs 123 can be sized to be inserted into respective ones of the grooves 124 (FIG. 3D) so as to attach the second bushing 122b to the housing 102 when the second bushing 122b is disposed in the hole 127. In one example, the second bushing 122b can be insert molded within the hole 127 of the housing 102. As seen in FIG. 4A, the housing 102 can further include a retention rib 123 that extends from the inside surface 127a and is sized to be inserted into the circumferential groove 128 in the outer surface 125 of the bushing 122b. The housing 102 can include a retention rib 123 that is sized to be inserted into respective groove 128 so as to attach the bushing 122b to the housing 102. The bushing 122a can be retained from moving along the axial direction A by the retention rib 132 mating with the groove 128 (FIG. 3D).

In certain examples, the housing 102 can include a multiple of crush limiters 134 can be used in mounting the housing 102 to an external surface (not shown) such as a part of an engine or a vehicle body. As known in the art, the crush limiters 134 can be configured as metal inserts located in holes 134a in the housing 102 to withstand a compressive force induced during the assembly of a mating screw or bolt (not shown) where the screw or bolt (not shown) can be inserted through the crush limiter 134 to attach the housing 102 to the external surface (not shown). In an example, the material of the housing 102 can be PEI (e.g., Ultem 2400 or 3452).

Referring now to FIGS. 5A-5E, and as described above, the pendulum 104 can include an stiffener 144. In particular, the pendulum 104 stiffener 144 pendulum 104 can include an annular body 144a having a radially inner pendulum surface 141a and a radially outer pendulum surface 141b that is opposite the radially inner pendulum surface 141a. The stiffener 144 can similarly include an annular body 144a having a radially inner stiffener surface 144b and a radially outer stiffener surface 144c that is opposite the radially inner stiffener surface 144b. In an example, the stiffener 144 can be located in the pendulum 104 and the stiffener 144 can be referred to as an insert. The pendulum 104 can include fillets 143 and core outs 146 to add bending stiffness. In an example, the pendulum can include a spring locator 148 that can be inserted into an end of a spring (not shown). In some examples, the pendulum 104 can be made of a metal-plastic or metal-composite hybrid material. The stiffener 144 can be made of a metal so as to enhance the stiffness of the pendulum body 104a, while allowing the inner surface 141a of the pendulum body 104a to be plastic. In some examples the pendulum 104 can include ribs 158 to increase the strength and stiffness of the pendulum 104.

As discussed more fully in reference to FIGS. 6-7C, as the rotor 106 rotates during operation, the vanes 112 of the rotor 106 can contact the inner surface 141a of the pendulum body 104a during operation. Therefore the materials chosen for the inner surface of the pendulum 104 and the vanes 112 should be selected so as to have reduced friction and increased wear resistance between the inner surface 141a of the pendulum body 104a and the vanes 112. In an example, if the vanes 112 are made of plastic, then it can be beneficial for the inner surface 141a of the pendulum body 104a to be made of plastic as well. Similarly, if the vanes 112 are made of metal, then it can be beneficial for the inner surface 141a of the pendulum body 104a to be made of metal. In examples where the oil pressure is low, a high stiffness all-plastic pendulum can also be used, made of a PEI material such as LNP Thermocomp Compound EC008PXQ (also known as EC008PXQ, sold by Sabic Global Technologies, B.V.), which can be a simpler design as compared to a hybrid material pendulum. In examples of a plastic or hybrid design, the draft angle (e.g., the degree of taper of a side wall of a plastic part needed to allow the molded plastic part to be removed from a mold, typically ranging from about 0.5-2 degrees) of plastic parts can been used as an assembly aid to ensure the proper orientation of the plastic parts (e.g. pendulum, rotor, vanes, housing, cover, etc.). (See e.g., FIGS. 7A-7C). Pendulum slots 145 can be formed to reduce noise and flow ripple in the oil. Notches 147 can be added to aid in the oil filling from both sides of pendulum 104, which can reduce or eliminate pump cavitation. A hinge 149 can be included in the pendulum 104 to allow the pendulum 104 to pivot about the pendulum locator 149a (FIG. 4A) in the transverse direction T (FIG. 1A).

As known in the art of variable displacement vane pumps, in a variable displacement vane pump, such as pump 100, the distance from the rotor 106 to the pendulum 104 is used to determine the pump's displacement. By allowing the pendulum 104 to pivot or translate about the hinge 149 relative to the rotor 106, the displacement of the pump 100 can be varied. During operation, the pendulum 104 of the variable displacement vane pump 100 can pivot about the hinge 149 to change the length that the vanes 112 extend outward from the outer surface 153 of the rotor 106. In an example, during operation, as the inner surface 141a of the pendulum 104 is moved closer to the outer surface 153 of the rotor 106, the vanes 112 contacting the inner surface 141a of the pendulum 104 slide radially inward in the vane slots 152 towards the shaft 116 to change the displacement of the variable displacement vane pump 100. As a first set of vanes 112 move radially inward towards the shaft 116 by the pendulum 104, the vanes 112 push the outer vane ring 108a and the inner vane ring 108b radially inward towards the shaft 116, such that a second set of vanes 112 on an opposite side of the shaft 116 in the transverse direction T from the first set of vanes 112 are pushed away from the shaft 116 in the transverse direction T by the outer vane ring 108a and the inner vane ring 108b. In some examples, the rotor 106 can include ribs 155 to increase strength and stiffness of the rotor 106.

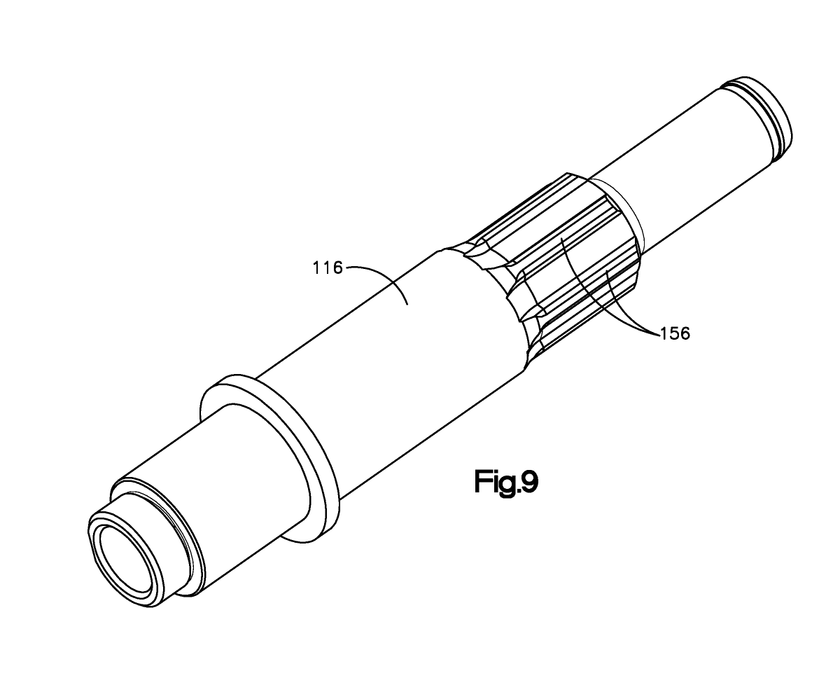

Referring now to FIG. 8, and as described above with respect to FIG. 1A, the variable displacement vane pump 100 can include an inner vane ring 108a and an outer vane ring 108b. The inner and outer vane rings 108a and 108b can be constructed as describe herein with reference to a vane ring 108 illustrated in FIG. 8. The inner vane ring 108a can be located between the rotor 106 and the housing 102 and the outer vane ring 108b can be located between the cover 130 and the rotor 106 as seen in FIG. 1A. In an example, the vane ring 108 can be made of a metal, such as steel.

Referring now to FIG. 9, and as described above with respect to FIG. 1A, the variable displacement vane pump 100 includes the shaft 116. The shaft 116 can have splines 156 that are oriented along the lateral direction A. The splines 156 can be sized to be inserted into respective grooves 154 (FIG. 6A) of the rotor 106 (FIG. 6A) so as to rotatably couple the shaft 116 to the rotor 106. Accordingly, during operation of the pump 100, rotation of the shaft 116 about the central axis can drive correspondingly drive the rotor 106 to rotate about the central axis. In an example, the shaft 116 can be made of a metal, such as steel. In another example, the shaft 116 can be made of a plastic or a composite.

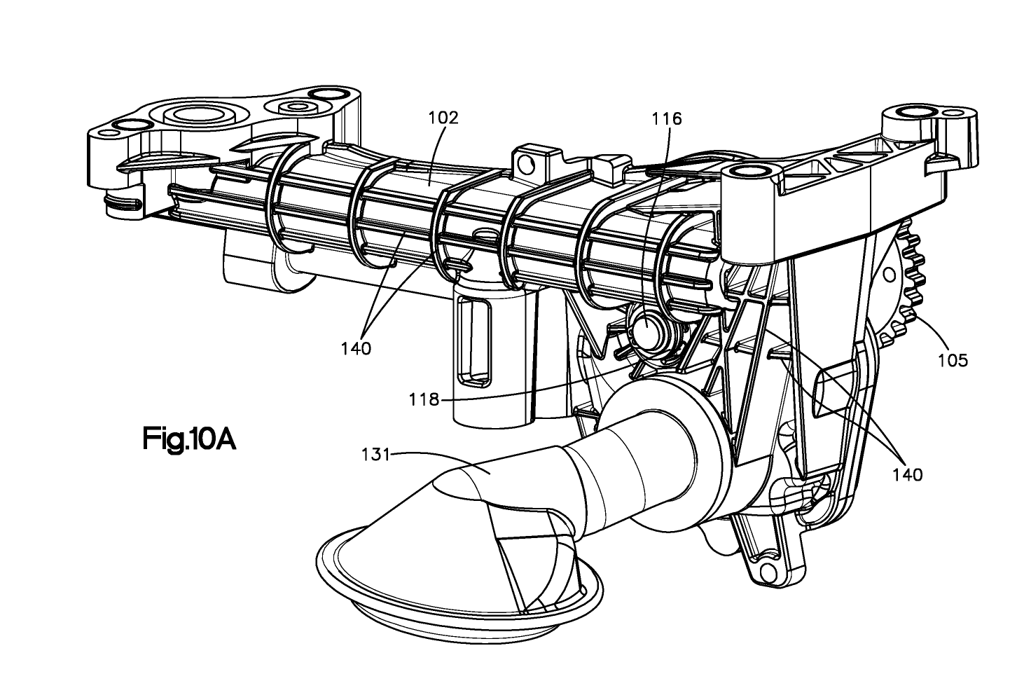

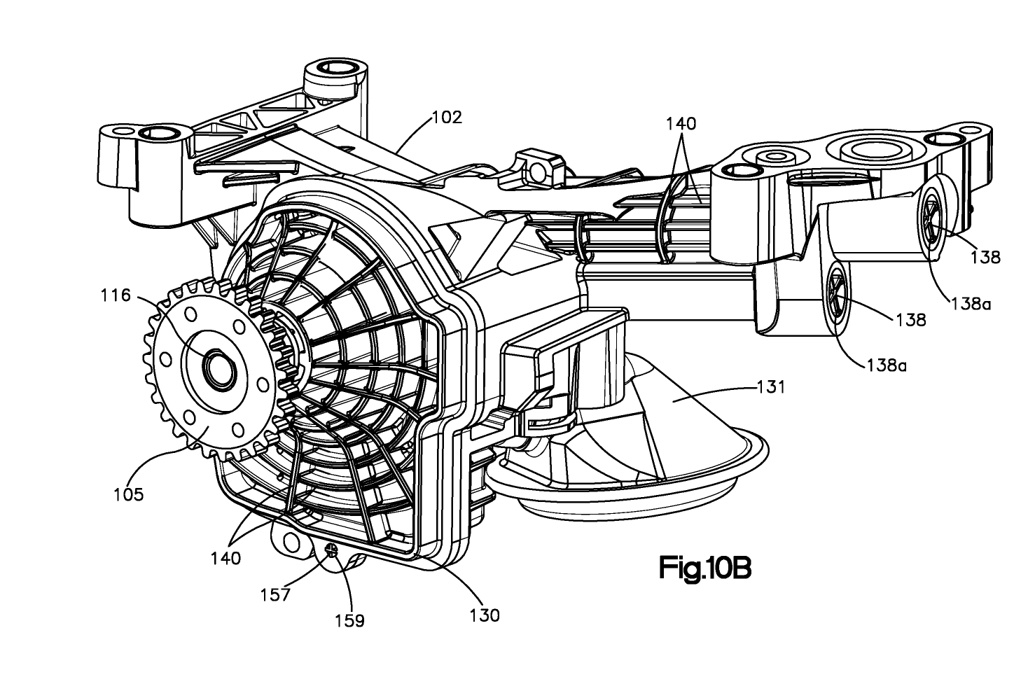

Referring now to FIGS. 10A-10B the housing 102 can include the pick-up tube 131. The variable displacement vane pump 100 can further include a chain gear 105. In the example shown in FIG. 10A, the pick-up tube 131 can be integrated with the housing 102, and the chain gear 105 can be disposed on an opposite side of the housing 102 with respect to the pick-up tube 131. In an example, the pick-up tube 131 can be connected to an oil pan (not shown) to provide oil or other liquid to the pump 100. In certain examples, the housing 102 can be formed integrally with the oil pan. In some examples, plug holes 138a formed during the molding process can be sealed with plugs 138. The plugs 138 can be retained in the plug holes 138a by welding, circlips, adhesives, or any suitable method. In the example shown in FIG. 10B, the chain gear 105 is shown coupled to the shaft 116 such that the when the chain gear is attached to a chain (not shown), actuation of the chain causes the chain gear 105, and thus the shaft 116, to rotate.

### EXAMPLES

It should be appreciated that the present disclosure can include any one up to all of the following examples:

### Example 1

A variable displacement pump, comprising:
a housing defining an upper surface, a lower surface opposite the upper surface, and an outer surface extending between the upper surface and the lower surface, the housing including an inlet and an outlet, the housing further defining an opening sized to receive a shaft;
a cover coupled to the upper surface of the housing, the cover defining an opening sized to receive the shaft;
a rotor positioned in the housing between the inlet and the outlet, the rotor defining an opening sized to receive the shaft, and the rotor being configured to pump a liquid between the inlet and the outlet, wherein the rotor defines a multiple of vane slots;
a multiple of vanes, each disposed in a respective one of the multiple of vane slots; and
a pendulum positioned between the rotor and the housing, the pendulum comprising a pendulum body and a stiffener, wherein the stiffener is located at least partially within the pendulum body, and wherein the rotor, the multiple of vanes, and the pendulum body are made of a polymer.

### Example 2

The variable displacement pump of example 1, wherein the stiffener is insert molded into the pendulum body, and wherein the stiffener is made of metal.

### Example 3

The variable displacement pump of example 2, wherein the rotor, the multiple of vanes, and the pendulum body are made the same polymer.

### Example 4

The variable displacement pump of any one of examples 1 to 3, wherein the cover comprises a dome shape defined by a multiple of ribs located on an exterior surface of the cover, a flange substantially surrounding a perimeter of the cover, a hole extending through the dome shape of the cover.

### Example 5

The variable displacement pump of example 4, wherein the cover comprises a bushing positioned in the hole, the bushing comprising at least one groove located on an exterior surface of the bushing extending in an axial direction, and wherein the cover comprises at least one retention rib that is inserted into the at least one groove of the bushing.

### Example 6

The variable displacement pump of examples 5, wherein the bushing defines inner surface and an outer surface such that the bushing defines a variable thickness between the inner surface and the outer surface, such that a first thickness at a first location between the inner surface and the outer surface of the bushing is greater than a second thickness at a second location between the inner surface and the outer surface of the bushing.

### Example 7

The variable displacement pump of any one of examples 5 to 6, wherein the rotor, the multiple of vanes, are made of a first material, and the pendulum body is made from a second material different from the first material.

### Example 8

The variable displacement pump of any one of examples 1 to 7, wherein the housing comprises ribs located on an exterior surface of the housing.

### Example 9

The variable displacement pump of any one of examples 1 to 8, wherein the housing comprises a hole through the housing, a bushing is positioned in the hole, and wherein the housing comprises at least one retention rib that engages a groove on the bushing.

### Example 10

The variable displacement pump of any one of examples 1 to 9, wherein the shaft defines a multiple of splines, the multiple of splines being configured to be inserted into a corresponding multiple of spline grooves in the rotor.

### Example 11

The variable displacement pump of any one of examples 1 to 10, wherein the rotor comprises a plurality of rotor arms wherein each vane slot is located opposite a spline groove of the rotor, and the vanes are configured to be slideable in a direction radially outward from the opening of the rotor.

### Example 12

The variable displacement pump of any one of examples 1 to 11, wherein the vanes are configured with a draft angle to be installed in the rotor by being inserted in an orientation to match a draft angle of the vane slots of the rotor.

### Example 13

The variable displacement pump of any one of examples 1 to 12, wherein the pendulum comprises ribs and fillets located on an exterior surface of the pendulum, and at least one core out located between the exterior surface and an interior surface of the pendulum.

### Example 14

The variable displacement pump of any of examples 1 to 13, wherein the housing, the cover, the rotor, the shaft, the multiple of vanes, or the pendulum are made of one or more of polyetherimide or polyetheretherketone.

### Example 15

A variable displacement pump, comprising:
a housing defining an upper surface, a lower surface opposite the upper surface, and an outer surface extending between the upper surface and the lower surface, the housing defining an inlet and an outlet, the housing further defining an opening sized to receive a shaft;
a rotor positioned in the housing between the inlet and the outlet, the rotor defining an opening sized to receive the shaft, and the rotor being configured to pump a liquid between the inlet and the outlet, wherein the rotor defines a multiple of vane slots;
a multiple of vanes, each disposed in a respective one of the multiple of vane slots; and
a pendulum positioned between the rotor and the housing, the pendulum comprising a pendulum body and a stiffener, wherein the stiffener is located within the pendulum body.

### Example 16

The displacement pump of example 15, wherein the rotor, the multiple of vanes, the pendulum body, and the stiffener are made of one or more of a polymer or a composite.

### Example 17

A method of making a variable displacement pump, comprising:
forming a housing defining an upper surface, a lower surface opposite the upper surface, and an outer surface extending between the upper surface and the lower surface, the housing defining an inlet and an outlet, the housing further defining an opening sized to receive a shaft;
positioning a rotor in the housing between the inlet and the outlet, the rotor defining an opening sized to receive the shaft, and the rotor being configured to pump a liquid between the inlet and the outlet, wherein the rotor defines a multiple of vane slots;
positioning a multiple of vanes, each in one of the multiple of vane slots; and
positioning a pendulum between the rotor and the housing, the pendulum comprising a pendulum body and a stiffener, wherein the stiffener is located within the pendulum body, and wherein the rotor, the multiple of vanes, the pendulum body, and the stiffener are made of one or more of a polymer or a composite.

### Example 18

The method of example 17, further comprising the steps of forming a cover sized to cover the cavity, the cover defining an opening sized to receive the shaft, and insert molding a bushing in the cover.

### Example 19

The method of any one of examples 17 to 18, further comprising the steps of inserting a plug into a plug hole of the housing, and attaching the plug to the plug hole by welding, circlips, or adhesive, wherein the housing comprises a pick-up tube molded as an integral part of the housing.

### Example 20

The method of any one of examples 17 to 19, further comprising the steps of inserting a locator pin of the housing into a locator pin receiving hole of the cover, wherein the locator pin is molded as an integral part of the housing, and attaching the cover to the housing by adhesive, gaskets, or welding a flange of the cover to the housing.

### Example 21

The displacement pump of any of examples 1 to 15, wherein the housing is made of a polymer.

### Example 22

The displacement pump of any of examples 1 to 15, wherein the cover is made of a polymer.

### Example 23

The method of example 20, wherein the step of welding can be performed by laser welding, ultrasonic welding, or vibration welding.

### Example 24

The method of any one of examples 17 to 19, wherein the cover is attached to the housing by adhesives, crush limiters, elastomeric gaskets, screws, or bolts.

### Example 25

The displacement pump of any of examples 1 to 15, wherein the pendulum includes an annular body having a radially inner pendulum surface and a radially outer pendulum surface that is opposite the radially inner pendulum surface.

### Example 26

The displacement pump of any of examples 2 to 3, wherein the stiffener 144 includes an annular body having a radially inner stiffener surface and a radially outer stiffener surface that is opposite the radially inner stiffener surface.

### Example 27

The displacement pump of any of examples 2 to 3, wherein the stiffener is an insert.

### Example 28

The displacement pump of any of examples 2 to 3, wherein the stiffener is made of a metal and the pendulum body is plastic.

### Example 29

The displacement pump of any of examples 1 to 15, the rotor is configured to rotate during operation, such that the vanes of the rotor contact an inner surface of the pendulum.

### Example 30

The displacement pump of example 12, wherein the draft angle is about 0.5-2 degrees.

### Example 31

The displacement pump of any of examples 1 to 15, wherein the housing, cover, rotor, vanes, pendulum, or stiffener can be formed with a draft angle.

### Example 32

The displacement pump of example 31, wherein the draft angle is about 0.5-2 degrees.

### Example 33

The displacement pump of any of examples 1 to 3, wherein the pendulum includes pendulum slots.

### Example 34

The displacement pump of any of examples 1 to 3, wherein the pendulum includes notches.

### Example 35

The displacement pump of any of examples 1 to 3, wherein the pendulum includes a hinge.

### Example 36

The displacement pump of any of examples 1 to 15, wherein each vane of the multiple of vanes rests freely within its corresponding vane slot such that the vanes can slide radially inward or outward in the vane slots.

### Example 37

The displacement pump of any of examples 33 to 36, wherein the rotor is configured to rotate, such that vane rings pushes vanes outward against an inner surface of the pendulum.

### Example 38

The displacement pump of any of examples 33 to 37, wherein the vane slots extend radially inward from an outer surface of the rotor.

### Example 39

The displacement pump of any of examples 33 to 38, wherein each of the vane slots can be located opposite a rotor arm.

### Example 40

The displacement pump of any of examples 33 to 39, wherein the rotor defines seven rotor arms and seven vane slots.

### Example 41

The displacement pump of example 33 to 40, wherein the, each of the vane slots are located opposite a rotor arm.

### Example 42

The displacement pump of any of examples 33 to 41, wherein a width of the vane slots at a top of the rotor are wider than the vane slots at the bottom of the rotor.

### Example 43

The displacement pump of example 7, wherein the shaft is positioned in the bushing of the cover.

### Example 44

The displacement pump of examples 43, wherein the bushing defines an annular inner surface and an outer surface that is opposite the inner surface.

### Example 45

The displacement pump of any of examples 43 to 44, wherein the bushing includes a multiple of grooves that extend into the outer surface toward the inner surface.

### Example 46

The displacement pump of any of examples 43 to 45, wherein the grooves are axially oriented and circumferentially spaced from each other.

### Example 47

The displacement pump of any of examples 43 to 46, wherein the grooves terminate at a location between the inner surface and the outer surface.

### Example 48

The displacement pump of any of examples 43 to 47, wherein the bushing defines an outer surface and at least one circumferential groove that extends into the outer surface.

### Example 49

The displacement pump of any of examples 43 to 48, wherein the bushing has a variable thickness between the inner surface and the outer surface.

### Example 50

The displacement pump of example 48, wherein the at least one circumferential groove can extend between adjacent ones of the axial grooves.

### Example 51

The displacement pump of any of examples 48 to 50, wherein a single circumferential groove can extend about an entirety of an outer circumference of the bushing.

### Example 52

The displacement pump of any of examples 48 to 51, wherein, and can intersect each of the axial grooves.

### Example 53

The displacement pump of any of examples 1 to 15, wherein the opening of the cover can be sized to receive the first bushing.

### Example 54

The displacement pump of example 53, wherein the cover includes a multiple of retention ribs that extend from the inside surface into the opening and are sized to be inserted into respective ones of the grooves of the first bushing so as to attach the first bushing to the cover.

### Example 55

The displacement pump of any of examples 53 to 54, wherein the retention ribs are inserted into respective ones of the grooves to prevent the first bushing from rotating with respect to the cover.

### Example 56

The displacement pump of any of examples 53 to 55, wherein the bushing is insert molded within the opening of the cover.

### Example 57

The displacement pump of any of examples 53 to 56, wherein the cover includes at least one retention rib that extends radially from the inside surface of the cover.

### Example 58

The displacement pump of any of examples 53 to 57, wherein the retention rib is configured to mate with the circumferential groove in the outer surface of the bushing so as to attach the first bushing to the cover.

### Example 59

The displacement pump of any of examples 53 to 58, wherein interference between the retention rib and the first bushing prevents the first bushing from moving with respect to the cover along an axial direction.

### Example 60

The displacement pump of any of examples 53 to 59, wherein the bushing contains four axial grooves, and one circumferential groove.

### Example 61

The displacement pump of any of examples 53 to 60, wherein the thickness of the base of the cover from the inner surface to the outer surface is about 2-5 millimeters.

### Example 62

The displacement pump of any of examples 53 to 61, wherein the thickness of the outer surface of the cover is about 3.5 millimeters.

### Example 63

The displacement pump of any of examples 53 to 62, wherein the bushing is made of metal, and the cover is made of plastic.

### Example 64

The displacement pump of any of examples 53 to 63, wherein the housing, the cover, the rotor, the multiple of vanes, the pendulum, and the stiffener are made of glass filled or glass and mineral filled polyetherimide.

### Example 65

The displacement pump of any of examples 53 to 64, wherein the cover includes at least one locator pin receiving hole.

### Example 66

The displacement pump of any of examples 53 to 65, wherein the housing includes at least one locator pin.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific examples in which the invention can be practiced. These examples are also referred to herein as “examples.” Such examples can include elements in addition to those shown or described.

However, the present inventors also contemplate examples in which only those elements shown or described are provided. Moreover, the present inventors also contemplate examples using any combination or permutation of those elements shown or described (or one or more examples thereof), either with respect to a particular example (or one or more examples thereof), or with respect to other examples (or one or more examples thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As used in the specification and in the claims, the term “comprising” can include the embodiments “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

What is claimed is:

1. A variable displacement pump, comprising:
a housing defining an upper surface, a lower surface opposite the upper surface, and an outer surface extending between the upper surface and the lower surface, the housing including an inlet and an outlet, the housing further defining an opening sized to receive a shaft;
a cover coupled to the upper surface of the housing, the cover defining an opening sized to receive the shaft;
a rotor positioned in the housing between the inlet and the outlet, the rotor defining an opening sized to receive the shaft, and the rotor being configured to pump a liquid between the inlet and the outlet, wherein the rotor defines a multiple of vane slots;
a multiple of vanes, each disposed in a respective one of the multiple of vane slots; and
a pendulum positioned between the rotor and the housing, the pendulum comprising a pendulum body and a stiffener, wherein the stiffener is located at least partially within the pendulum body, and wherein the rotor, the multiple of vanes, and the pendulum body are made of a polymer.

2. The variable displacement pump of claim 1, wherein the stiffener is insert molded into the pendulum body, and wherein the stiffener is made of metal.

3. The variable displacement pump of claim 1, wherein the rotor, the multiple of vanes, and the pendulum body are made the same polymer.

4. The variable displacement pump of claim 1, wherein the cover comprises a dome shape defined by a multiple of ribs located on an exterior surface of the cover, a flange substantially surrounding a perimeter of the cover, a hole extending through the dome shape of the cover.

5. The variable displacement pump of claim 1, wherein the cover comprises a bushing positioned in the hole, the bushing comprising at least one groove located on an exterior surface of the bushing extending in an axial direction, and wherein the cover comprises at least one retention rib that is inserted into the at least one groove of the bushing.

6. The variable displacement pump of claim 5, wherein the bushing defines inner surface and an outer surface such that the bushing defines a variable thickness between the inner surface and the outer surface, such that a first thickness at a first location between the inner surface and the outer surface of the bushing is greater than a second thickness at a second location between the inner surface and the outer surface of the bushing.

7. The variable displacement pump of claim 1, wherein the rotor, the multiple of vanes, are made of a first material, and the pendulum body is made from a second material different from the first material.

8. The variable displacement pump of claim 1, wherein the housing comprises ribs located on an exterior surface of the housing.

9. The variable displacement pump of claim 1, wherein the housing comprises a hole through the housing, a bushing is positioned in the hole, and wherein the housing comprises at least one retention rib that engages a groove on the bushing.

10. The variable displacement pump of claim 1, wherein the shaft defines a multiple of splines, the multiple of splines being configured to be inserted into a corresponding multiple of spline grooves in the rotor.

11. The variable displacement pump of claim 1, wherein the rotor comprises a plurality of rotor arms wherein each vane slot is located opposite a spline groove of the rotor, and the vanes are configured to be slideable in a direction radially outward from the opening of the rotor.

12. A method of making a variable displacement pump, comprising:
forming a housing defining an upper surface, a lower surface opposite the upper surface, and an outer surface extending between the upper surface and the lower surface, the housing defining an inlet and an outlet, the housing further defining an opening sized to receive a shaft;
positioning a rotor in the housing between the inlet and the outlet, the rotor defining an opening sized to receive the shaft, and the rotor being configured to pump a liquid between the inlet and the outlet, wherein the rotor defines a multiple of vane slots;
positioning a multiple of vanes, each in one of the multiple of vane slots; and
positioning a pendulum between the rotor and the housing, the pendulum comprising a pendulum body and a stiffener, wherein the stiffener is located within the pendulum body, and wherein the rotor, the multiple of vanes, the pendulum body, and the stiffener are made of one or more of a polymer or a composite.

13. The method of claim 12, further comprising the steps of forming a cover sized to cover the cavity, the cover defining an opening sized to receive the shaft, and insert molding a bushing in the cover.

14. The method of claim 12, further comprising the steps of inserting a plug into a plug hole of the housing, and attaching the plug to the plug hole by welding, circlips, or adhesive, wherein the housing comprises a pick-up tube molded as an integral part of the housing.

15. The method of claim 12, further comprising the steps of inserting a locator pin of the housing into a locator pin receiving hole of the cover, wherein the locator pin is molded as an integral part of the housing, and attaching the cover to the housing by adhesive, gaskets, or welding a flange of the cover to the housing.
